(19) United States
(12) Patent Application Publication
(10) Pub. No.: US 2019/0219261 A1
(43) Pub. Date: Jul. 18, 2019

(54) Light Emitting Device Configured For Use In Clothes Dryer

(71) Applicants: Michael James Lee, Rego Park, NY (US); James Maximus Lee, Rego Park, NY (US)

(72) Inventors: Michael James Lee, Rego Park, NY (US); James Maximus Lee, Rego Park, NY (US)

(21) Appl. No.: 16/225,059

(22) Filed: Dec. 19, 2018

Related U.S. Application Data
(60) Provisional application No. 62/617,717, filed on Jan. 16, 2018.

(51) Int. Cl. F21V 33/00; F21V 19/00; F21V 23/02; D06F 58/04; D06F 58/28

(52) U.S. Cl. CPC F21V 33/0044; F21V 19/001; F21Y 2115/10; D06F 58/04; D06F 58/28; F21V 23/02

(57) ABSTRACT

A light emitting device is disclosed that is configured to be attached to a drum of a clothes dryer. The device includes a device body having a first portion and a second portion that is rotatably coupled to the first portion. The light emitting device further includes a light source supported by the device body, and a power source supported by the device body. The power source is electrically connected to the light source so as to power the light source.

### CROSS REFERENCE TO RELATED APPLICATIONS

This application claims the benefit of U.S. Provisional Application No. 62/617,717, filed Jan. 16, 2018, the entirety of which is incorporated herein for any and all purposes.

### TECHNICAL FIELD

The present disclosure is related to embodiments of a device configured to emit light. More specifically, the present disclosure includes embodiments of a device configured to emit light inside a drum of a clothes dryer.

### BACKGROUND

It is known that ultraviolet light has germicidal properties. Ultraviolet light is used in scientific labs, hospitals, and by consumers to disinfect equipment, water, and air. It is also known that infrared light produces heat. Incorporating a device configured to emit ultraviolet light, infrared light, or both into a clothes drying machine may result in more efficient operation of the clothes drying machine.

### SUMMARY

According to one aspect of the disclosure, a light emitting device that is configured to be attached to a drum of a clothes dryer includes a device body including a first portion and a second portion that is rotatably coupled to the first portion. The light emitting device further includes a light source supported by the device body, and a power source supported by the device body and electrically connected to the light source so as to power the light source.

According to another aspect, a clothes dryer includes a drum, a motor configured to rotate at least a portion of the drum, and a light emitting device configured to be attached to the drum. The light emitting device includes a device body having a first portion and a second portion, the second portion rotatably coupled to the first portion. The light emitting device further has a light source supported by the device body and a power source supported by the device body and electrically connected to the light source so as to power the light source.

According to another aspect of the disclosure, a method of drying clothes in a clothes dryer includes the steps of placing clothes within a drum of a clothes dryer; rotating the drum about a first axis; rotating a first portion of a light emitting device relative to a second portion of a light emitting device about a second axis, thereby providing power to a light source of the light emitting device; and emitting light from a light source of the light emitting device.

### BRIEF DESCRIPTION OF THE DRAWINGS

The foregoing summary, as well as the following detailed description of illustrative embodiments of the application, will be better understood when read in conjunction with the appended drawings. For the purposes of illustrating the present disclosure, there is shown in the drawings illustrative embodiments. It should be understood, however, that the application is not limited to the specific embodiments and methods disclosed, and reference is made to the claims for that purpose. In the drawings:

FIG. 1 is a front elevation view of a clothes dryer including a light emitting device, the clothes dryer in a closed configuration;

FIG. 2 is a front elevation view of the clothes dryer illustrated in FIG. 1, the clothes dryer including the light emitting device according to one embodiment of the disclosure, and the clothes dryer in an open configuration;

FIG. 3 is side elevation view of the clothes dryer illustrated in FIG. 1;

FIG. 4 is a side cross-sectional view of the clothes dryer illustrated in FIG. 3, along line 4-4.

FIG. 5 is a front cross-sectional view of the clothes dryer illustrated in FIG. 1, along line 5-5;

FIG. 6 is a side elevation view of a light emitting device according to one embodiment of the disclosure;

FIG. 7 is a side elevation view of a light emitting device according to another embodiment of the disclosure;

FIG. 8 is a front elevation view of the light emitting device illustrated in FIG. 7;

FIG. 9 is a side elevation view of a light emitting device according to another embodiment of the disclosure; and

FIG. 10 is a front elevation view of the light emitting device illustrated in FIG. 9.

### DETAILED DESCRIPTION OF ILLUSTRATIVE EMBODIMENTS

Certain terminology is used in the following description for convenience only and is not limiting. The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Aspects of the disclosure will now be described in detail with reference to the drawings, wherein like reference numbers refer to like elements throughout, unless specified otherwise. Certain terminology is used in the following description for convenience only and is not limiting. The term “plurality,” as used herein, means more than one. The terms “a portion” and “at least a portion” of a structure include the entirety of the structure. Certain features of the disclosure, which are described herein in the context of separate embodiments, may also be provided in combination in a single embodiment. Conversely, various features of the disclosure that are described in the context of a single embodiment may also be provided separately or in any subcombination.

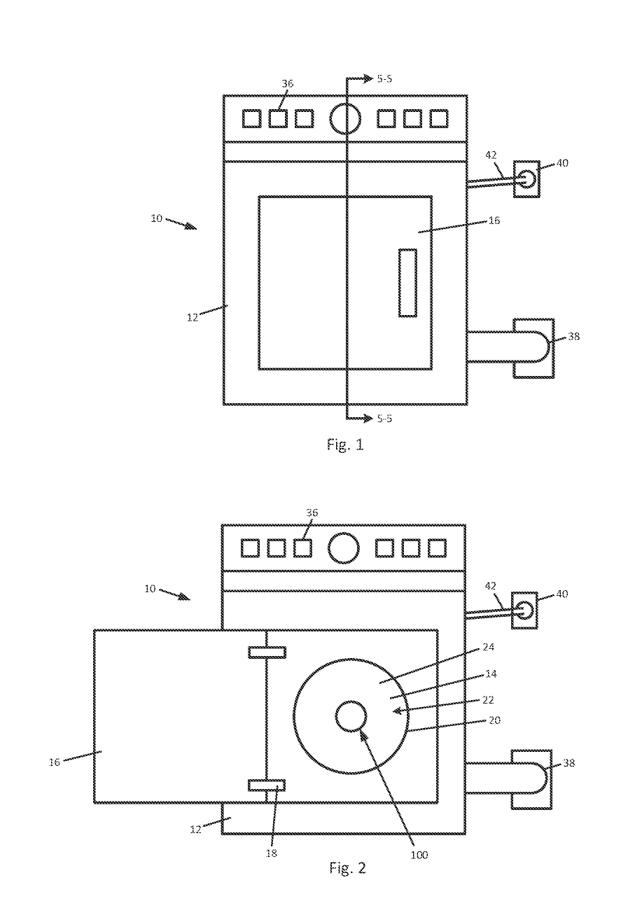

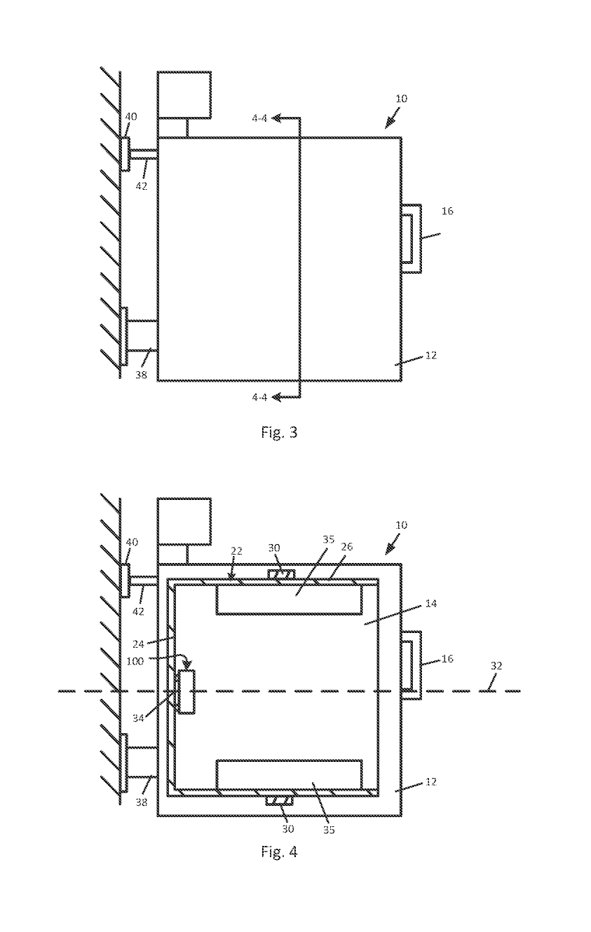

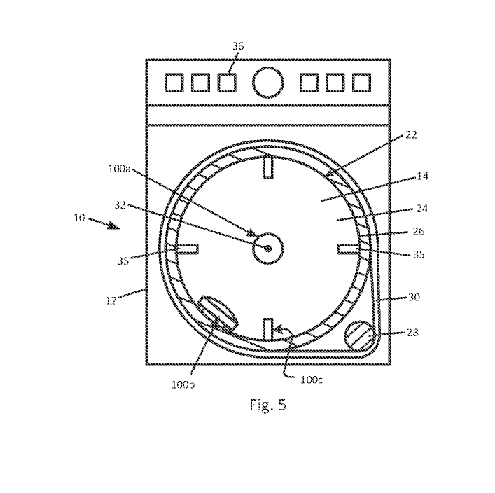

Referring to FIGS. 1 to 5, a clothes drying machine 10 (hereinafter machine 10) includes a housing 12 that defines an interior space 14. The machine 10 defines a closed configuration (shown in FIG. 1) in which the interior space 14 is completely enclosed by the housing 12. The machine 10 further defines an open configuration (shown in FIG. 2) in which the interior space 14 is accessible. The housing 12 of the machine 10 may include a door 16 coupled to the housing 12 such that movement of the door 16, for example rotation about one or more hinges 18, transitions the machine 10 from the closed configuration to the open configuration.

The housing 12 defines an opening 20 that provides a passageway into the interior space 14 from an exterior of the machine 10. In the closed configuration, the door 16 blocks the opening 20, and in the open configuration the door 16 does not block the opening 20. In the open configuration, the machine 10 is configured to be loaded, for example with wet clothes, through the opening 20 and into the interior space 14. Once the machine 10 is loaded, the door 16 is configured to close and be secured so as to remain closed during a drying operation of the machine 10.

The machine 10 may further include a drum 22 positioned within the interior space 14 and enclosed by the housing 12. According to one embodiment, the drum 22 may be cylindrical in shape, such that the drum 22 includes a base surface 24 and a sidewall 26. The base surface 24 may be a substantially circular shape and the sidewall 26 is substantially ring shaped. The drum 22 is configured such that at least a portion of the drum 22, including just the base surface 24, just the sidewall 26, or both the base surface 24 and the sidewall 26 is rotatable relative to the housing 12.

According to one aspect of the disclosure, the base surface 24 and the sidewall 26 are secured together such that movement, including translation, rotation, and both translation and rotation, of the base surface 24 relative to the sidewall 26 is prevented. According to one embodiment, the base surface 24 and the sidewall 26 may be monolithic. According to another aspect of the disclosure, the drum 22 is configured such that base surface 24 is able to move, for example translate, rotate, or both, relative to the sidewall 26.

The machine 10 may include a motor 28 configured to rotate the drum 22 relative to the housing 12. As shown in the illustrated embodiment, the machine 10 may include a mechanism 30, for example a belt, coupled to both the motor 28 and the drum 22 such that torque generated by the motor 28 is transferred to the drum 22 by the mechanism 30, and the transferred torque rotates the drum 22 relative to the housing 12 about an first axis of rotation 32. According to one aspect of the disclosure, the base surface 24 defines a center 34, and the first axis of rotation 32 intersects the center 34.

The drum 22 may further include at least one baffle 35 configured to agitate the load, for example the clothes, positioned within the drum 22. As shown in the illustrated embodiment, each of the at least one baffle 35 extends from the sidewall 26 toward the first axis of rotation 32. The at least one baffle 35 may be removable from the sidewall 26, or alternatively integral with the sidewall 26.

The machine 10 may include other components found in known clothes drying machines such as, but not limited to, controls 36 configured to operate the clothes drying machine, a heating element, a blower, a vent 38 configured to exhaust air from the interior space 14, etc., an electrical system that is connected to a power source. The power source may include an electrical outlet 40, and the machine 10 includes an electrical cord 42 plugged into the electrical outlet 40. The electrical system may be configured to deliver power from the power source to other components of the machine 10, including but not limited to, the motor 28, the controls 36, the heater, etc.

The machine 10 may include a light emitting device 100 (hereinafter the device 100) configured to be supported by the machine 10. The device 100 is configured to improve, increase, or the ability of the machine 10 to dry a load that is positioned in the interior space 14. The device 100 may be is configured to emit light into the interior space 14. According to one embodiment, the device 100 is a separate from the machine 10 such that the device 100 is configured to be removably attached to the machine 10. For example, the device 100 may be configured to retrofit a machine 10. According to another embodiment, the device 100 may be an integral component of the machine 10. For example, the device 100 may be permanently secured to the machine 10, such that the device 100 cannot be removed from the machine 10 without plastically deforming at least one of the machine 10 and the device 100.

The machine 10 may include a light filtering assembly configured to block light emitted from the device 100 from leaving the interior space 14 when the machine 10 is in the closed configuration. The machine 10 may include a locking assembly configured to prevent the machine 10 from transitioning from the closed configuration to the open configuration while the device 100 is emitting light. The machine 10 may include a cutoff assembly configured to stop the device 100 from emitting light when the machine 10 is transitioned from the closed configuration to the open configuration.

As shown in the illustrated embodiment, the device 100 may be configured to be supported by the drum 22. For example, the device 100 may be supported by the base surface 24, the sidewall 26, or both. The machine 10 may include a plurality of the devices 100. For example, the machine 10 may include a first device 100a, a second device 100b, a third device 100c, or any combination thereof. Reference to the device 100 herein is applicable to each of the first device 100a, the second device 100b, and the third device 100c.

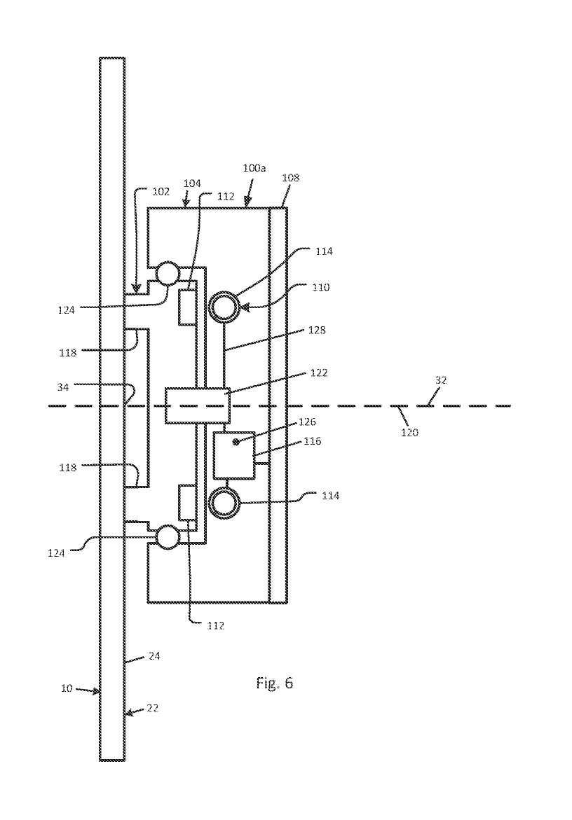

Referring to FIGS. 6 to 10, the device 100 may include a device body, and the device body may include a first portion 102 and a second portion 104. According to one aspect of the disclosure, the second portion 104 is rotatable relative to the first portion 102. The device 100 includes a light source 108 supported by the device body, and the device 100 further includes a power source 110 supported by the device body. As shown in the illustrated embodiment, the power source 110 is electrically connected to the light source 108 so as to power the light source 108. The light source 108 may be configured to be heat resistant, impact resistant, moisture resistant, or any combination thereof.

The power source 110 may include a stator 112 configured to produce a magnetic field, and the power source 110 may further include an armature, for example a conductive member 114, configured to move through the magnetic field thereby generating electricity. The stator 112 may be supported by one of the first portion 102 and the second portion 104. According to one aspect of the disclosure, the conductive member 114 may be supported by the other of the first portion 102 and the second portion 104 such that the conductive member 114 is both rotatable relative to the stator 112, and rotatable through the magnetic field. According to one embodiment, the stator 112 may include at least one permanent magnet, at least one electromagnet, or both. According to one embodiment, the conductive member 114 includes a coiled wire. As shown in the illustrative embodiments, the power source 110 may include a battery 116. The battery 116 may be rechargeable, for example a lithium ion battery. The battery 116 may be configured to be charged through an alternating current adapter, a direct current adapter, or both.

As shown in the illustrated embodiment, the power source 110 may include one or more wires 128 configured to carry the generated electricity to the light source 108. The generated electricity may be delivered to the battery 116, where the power may be stored until needed to power the light source 108. The light source 108 may be configured to emit ultraviolet light, infrared light, or both. According to one aspect of the disclosure, the light source 108 may be configured to emit ultraviolet light with a wavelength between about 265 nm to about 280 nm. According to one aspect of the disclosure, the light source 108 may include a light emitting diode. The device 100 may include an ozone generator.

Referring to FIG. 6, the first device 100a is configured to be attached to a portion of the drum 22 that rotates. As shown in the illustrated embodiment, the first device 100a may be attached to the base surface 24 of the drum 22, and the base surface 24 is rotatable about the first axis of rotation 32. The first portion 102 may include one or more feet 118 configured to attach the first device 100a to the base surface 24. The feet 118 may include magnets, suction cups, Velcro, adhesives, or other such mechanisms configured to secure the first portion 102 to the base surface 24 such that movement of the base surface 24 relative to the first portion 102 is prevented. Thus, the first device 100a may be configured to be attached to the base surface 24 such that rotation of the base surface 24 about the first axis of rotation 32 also rotates the first portion 102 about the first axis of rotation 32.

As shown in the illustrated embodiment, the second portion 104 may be rotatable relative to the first portion 102 about a second axis of rotation 120. The first device 100a may include an axle 122, bearings 124, or both configured to enable rotation of the second portion 104 relative to the first portion 102. The axle 122 may include a dynamo generator that is part of the power source 110. The first device 100a may be attached to the drum 22 such that the first axis of rotation 32 is parallel to the second axis of rotation 120. The first device 100a may be attached to the drum 22 such that the first axis of rotation 32 is coincident with the second axis of rotation 120.

The second portion 104 may define a center of gravity 126, and the first device 100a may be configured such that the center of gravity 126 is offset from the second axis of rotation 120. As shown in the illustrated embodiment, the center of gravity 126 is offset from the second axis of rotation 120 by a distance measured in a direction that is perpendicular to the second axis of rotation 120. According to one aspect of the disclosure, the battery 116 is positioned within the second portion 104 so as to result in the center of gravity 126 being offset from the second axis of rotation 120.

Friction, among other factors, may result in the second portion 104 rotating about the second axis of rotation 120 in response to rotation of the first portion 102 about the second axis of rotation 120. The first device 100a being configured to have a center of gravity 126 of the second portion 104 that is offset from the second axis of rotation 120 may result in less rotation of the second portion 104 about the second axis of rotation 120 in response to the rotation of the first portion 102 about the second axis of rotation 120.

According to one embodiment, the first device 100a is configured to be attached to the base surface 24 of the drum 22. After the first device 100a is attached to the base surface 24, the base surface 24 may be rotated during a drying operation of the machine 10. Rotation of the base surface 24 about the first axis of rotation 32 results in rotation of the first portion 102 relative to the second portion 104 about the second axis of rotation 120, which may be coincident with the first axis of rotation 32. The first device 100a may be mounted to the base surface 24 such that the first axis of rotation 32, the second axis of rotation 120, or both intersect the center 34 of the base surface 24.

One of the first portion 102 and second portion 104 directly supports the stator 112, and the other of the first portion 102 and second portion 104 directly supports the conductive member 114. As shown in the illustrated embodiment, the first portion 102 directly supports the stator 112, and the second portion 104 directly supports the conductive member 114. Rotation of the first portion 102 relative to the second portion 104 results in rotation of the stator 112 relative to the conductive member 114. The rotation of the stator 112 relative to the conductive member 114 generates electricity, which may be carried to the light source 108 to provide power to the light source 108 thereby enabling the light source 108 to emit light.

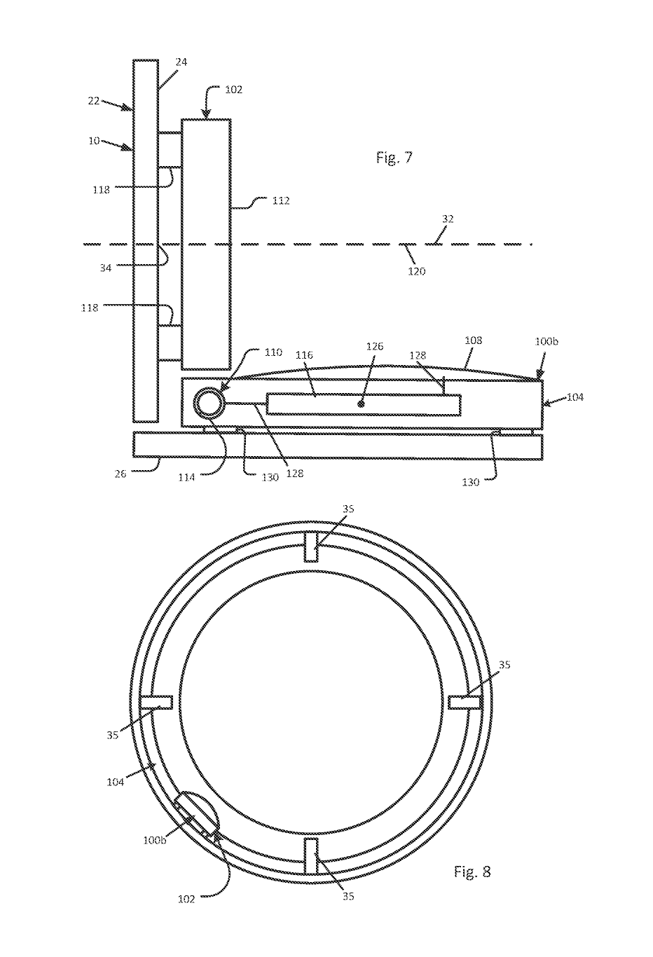

Referring to FIGS. 7 and 8, the second device 100b may configured to be attached to both a portion of the drum 22 that rotates and a portion of the drum 22 that does not rotate. As shown in the illustrated embodiment, the first portion 102 of the second device 100b may be attached to the base surface 24 of the drum 22, the second portion 104 of the second device 100b may be attached to the sidewall 26 of the drum 22, and the sidewall 26 rotates about the first axis of rotation 32 relative to the base surface 24 during a drying operation of the machine 10. The first portion 102 may include one or more feet 118 configured to attach the second device 100b to the base surface 24. The feet 118 may include magnets, suction cups, Velcro, adhesives, or other such mechanisms configured to secure the first portion 102 to the base surface 24 such that movement of the base surface 24 relative to the first portion 102 is prevented.

As shown in the illustrated embodiment, the second portion 104 may be rotatable relative to the first portion 102 about a second axis of rotation 120. The second portion 104 includes feet 130 configured to attach the second portion 104 to the sidewall 26. The feet 130 may include magnets, suction cups, Velcro, adhesives, or other such mechanisms configured to secure the second portion 104 to the sidewall 26 such that movement of the sidewall 26 relative to the second portion 104 is prevented. The second device 100b may be attached to the drum 22 such that the first axis of rotation 32 is coincident with the second axis of rotation 120.

The second device 100b may be configured such that the center of gravity 126 of the second portion 104 is offset from the second axis of rotation 120. As shown in the illustrated embodiment, the center of gravity 126 is offset from the second axis of rotation 120 by a distance measured in a direction that is perpendicular to the second axis of rotation 120.

According to one embodiment, the first portion 102 of the second device 100b is configured to be attached to the base surface 24, and the second portion 104 of the second device 100b is configured to be attached to the sidewall 26. After the second device 100b is attached to the base surface 24 and the sidewall 26, the sidewall 26 may be rotated relative to the base surface 24 during a drying operation of the machine 10. Rotation of the sidewall 26 about the first axis of rotation 32 results in rotation of the second portion 104 relative to the first portion 102 about the second axis of rotation 120, which may be coincident with the first axis of rotation 32. The second device 100b may be mounted to the drum 22 such that the first axis of rotation 32, the second axis of rotation 120, or both intersect the center 34 of the base surface 24.

One of the first portion 102 and second portion 104 directly supports the stator 112, and the other of the first portion 102 and second portion 104 directly supports the conductive member 114. As shown in the illustrated embodiment, the first portion 102 directly supports the stator 112, and the second portion 104 directly supports the conductive member 114. Rotation of the second portion 104 relative to the first portion 102 results in rotation of the conductive member 114 relative to the stator 112. The rotation of the conductive member 114 relative to the stator 112 generates electricity, which may be carried to the light source 108 to provide power to the light source 108 thereby enabling the light source 108 to emit light.

The second portion 104 of the second device 100b may be positioned between adjacent ones of the baffles 35 of the machine 10.

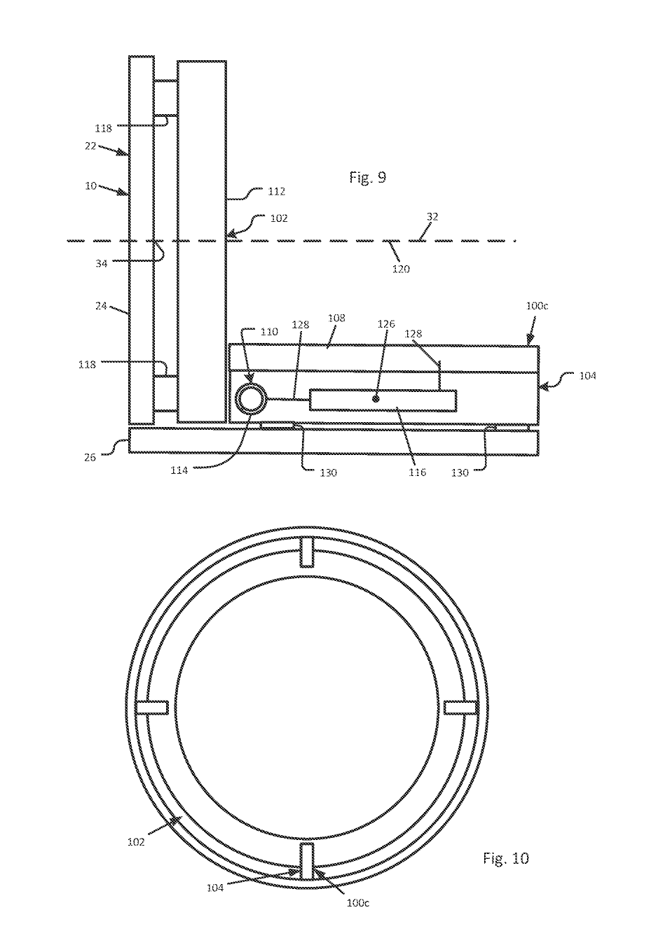

Referring to FIGS. 9 and 10, the third device 100c may configured to be attached to both a portion of the drum 22 that rotates and a portion of the drum 22 that does not rotate. As shown in the illustrated embodiment, the first portion 102 of the third device 100c may be attached to the base surface 24 of the drum 22, the second portion 104 of the second device 100b may be attached to the sidewall 26 of the drum 22, and the sidewall 26 rotates about the first axis of rotation 32 relative to the base surface 24 during a drying operation of the machine 10. The first portion 102 may include one or more feet 118 configured to attach the third device 100c to the base surface 24. The feet 118 may include magnets, suction cups, Velcro, adhesives, or other such mechanisms configured to secure the first portion 102 to the base surface 24 such that movement of the base surface 24 relative to the first portion 102 is prevented.

As shown in the illustrated embodiment, the second portion 104 may be rotatable relative to the first portion 102 about a second axis of rotation 120. The second portion 104 includes feet 130 configured to attach the second portion 104 to the sidewall 26. The feet 130 may include magnets, suction cups, Velcro, adhesives, or other such mechanisms configured to secure the second portion 104 to the sidewall 26 such that movement of the sidewall 26 relative to the second portion 104 is prevented. The third device 100c may be attached to the drum 22 such that the first axis of rotation 32 is coincident with the second axis of rotation 120.

The third device 100c may be configured such that the center of gravity 126 of the second portion 104 is offset from the second axis of rotation 120. As shown in the illustrated embodiment, the center of gravity 126 is offset from the second axis of rotation 120 by a distance measured in a direction that is perpendicular to the second axis of rotation 120.

According to one embodiment, the first portion 102 of the third device 100c is configured to be attached to the base surface 24, and the second portion 104 of the third device 100c is configured to be attached to the sidewall 26. After the third device 100c is attached to the base surface 24 and the sidewall 26, the sidewall 26 may be rotated relative to the base surface 24 during a drying operation of the machine 10. Rotation of the sidewall 26 about the first axis of rotation 32 results in rotation of the second portion 104 relative to the first portion 102 about the second axis of rotation 120, which may be coincident with the first axis of rotation 32. The third device 100c may be mounted to the drum 22 such that the first axis of rotation 32, the second axis of rotation 120, or both intersect the center 34 of the base surface 24.

One of the first portion 102 and second portion 104 directly supports the stator 112, and the other of the first portion 102 and second portion 104 directly supports the conductive member 114. As shown in the illustrated embodiment, the first portion 102 directly supports the stator 112, and the second portion 104 directly supports the conductive member 114. Rotation of the second portion 104 relative to the first portion 102 results in rotation of the conductive member 114 relative to the stator 112. The rotation of the conductive member 114 relative to the stator 112 generates electricity, which may be carried to the light source 108 to provide power to the light source 108 thereby enabling the light source 108 to emit light.

The second portion 104 of the third device 100c may be in the form of the baffle 35 of the machine 10. The third device 100c may be configured to replace one of the baffles 35 of the machine 10 and provide both agitation as the replaced baffle 35 did, in addition to emitting light to improve the drying operation.

Referring to FIGS. 1 to 10, a method of drying clothes in the machine 10 may include the steps of placing clothes within the drum 22 of the machine 10, rotating the drum 22 about the first axis of rotation 32, rotating the first portion 102 of the device 100 relative to the second portion 104 of the device 100 about the second axis of rotation 120, thereby providing power to the light source 108 of the device 100, emitting light from the light source 108, or any combination thereof.

The method may further include the step of securing the first portion 102 to the base surface 24 of the drum 22 such that movement of the first portion 102 relative to the base surface 24 is prevented. The step of rotating the drum 22 may include the step of rotating the base surface 24 and the first portion 102 simultaneously. The method may further include the step of securing the second portion 104 to the sidewall 26 of the drum 22. The step of rotating the drum 22 may include the step of rotating the sidewall 26 and the second portion 104 simultaneously. According to one aspect of the disclosure, the base surface 24 and the first portion 102 remain stationary during the step of rotating the drum 22.

The light source 108 may be supported by the second portion 104, and the method may further include the step of charging the battery 116. The battery 116 may be both supported by the second portion 104 and electrically connected to the light source 108.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein. All methods described herein can be performed in any suitable order unless otherwise indicated herein or otherwise clearly contradicted by context.

Although the disclosure has been described in detail, it should be understood that various changes, substitutions, and alterations could be made herein without departing from the spirit and scope of the invention as defined by the appended claims. Moreover, the scope of the present disclosure is not intended to be limited to the particular embodiments described in the specification. As one of ordinary skill in the art will readily appreciate from the disclosure of the present invention, processes, machines, manufacture, composition of matter, means, methods, or steps, presently existing or later to be developed that perform substantially the same function or achieve substantially the same result as the corresponding embodiments described herein may be utilized according to the present disclosure.

What is claimed is:

1. A light emitting device configured to be attached to a drum of a clothes dryer, the light emitting device comprising:
a device body including a first portion and a second portion, the second portion rotatably coupled to the first portion;
a light source supported by the device body; and
a power source supported by the device body and electrically connected to the light source so as to power the light source.

2. The light emitting device of claim 1, wherein the power source includes a stator configured to produce a magnetic field, and the power source further includes a conductive member, the stator is supported by one of the first portion and the second portion, and the conductive member is supported by the other of the first portion and the second portion such that the conductive member is rotatable 1) relative to the stator, and 2) through the magnetic field.

3. The light emitting device of claim 2, wherein the stator includes at least one of a permanent magnet and an electromagnet.

4. The light emitting device of claim 2, wherein the conductive member includes coiled wire.

5. The light emitting device of claim 1, wherein the first portion is configured to be secured to a surface of the drum such that movement of the surface relative to the first portion is prevented.

6. The light emitting device of claim 1, wherein the power source is configured such that rotation of the second portion relative to the first portion creates an electrical current, and the power source is further configured to deliver the electrical current to the light source.

7. The light emitting device of claim 1, wherein the power source includes a battery electrically connected to the light source.

8. The light emitting device of claim 1, wherein the second portion is rotatable relative to the first portion about an axis.

9. The light emitting device of claim 8, wherein the second portion defines a center of gravity, and the center of gravity is offset from the axis.

10. The light emitting device of claim 1, wherein the light source is configured to emit ultraviolet light, infrared light, or both.

11. The light emitting device of claim 10, wherein the light source is configured to emit ultraviolet light with a wavelength between about 265 nm to about 280 nm.

12. The light emitting device of claim 1, wherein the light source includes a light emitting diode.

13. The light emitting device of claim 1, further comprising an ozone generator.

14. A clothes dryer comprising:
a drum;
a motor configured to rotate at least a portion of the drum; and
a light emitting device configured to be attached to the drum, the light emitting device including:
a device body including a first portion and a second portion, the second portion rotatably coupled to the first portion;
a light source supported by the device body; and
a power source supported by the device body and electrically connected to the light source so as to power the light source.

15. The clothes dryer of claim 14, wherein the drum includes a base surface and a sidewall, the base surface is a circular shape, and the sidewall extends away from the base surface and is a cylindrical shape.

16. The clothes dryer of claim 15, wherein the first portion is secured to the base surface such that movement of the first portion relative to the base surface is prevented.

17. The clothes dryer of claim 16, wherein the second portion is indirectly supported by the drum only through the first portion.

18. The clothes dryer of claim 17, wherein the base surface is secured to the cylindrical surface such that movement of the base surface relative to the sidewall is prevented.

19. The clothes dryer of claim 16, wherein the second portion is directly supported by the sidewall.

20. The clothes dryer of claim 19, wherein the sidewall is rotatable with respect to the base surface.

21. The clothes dryer of claim 14, further comprising an electrical system configured to supply power to the motor to thereby rotate the drum, wherein the power source of the light emitting device is independent from the electrical system of the clothes dryer.

22. A method of drying clothes in a clothes dryer comprising the steps of:
placing clothes within a drum of a clothes dryer;
rotating the drum about a first axis;
rotating a first portion of a light emitting device relative to a second portion of a light emitting device about a second axis, thereby providing power to a light source of the light emitting device; and
emitting light from a light source of the light emitting device.

23. The method of claim 22, further comprising the step of securing the first portion to a surface of the dryer such that movement of the first portion relative to the surface is prevented.

24. The method of claim 23, wherein the step of rotating the drum includes the step of rotating the surface and the first portion simultaneously.

25. The method of claim 23, wherein the surface is a first surface, and the method further comprises the step of securing the second portion to a second surface of the dryer.

26. The method of claim 25, wherein the step of rotating the drum includes the step of rotating the second surface and the second portion simultaneously.

27. The method of claim 26, wherein the first surface and the first portion remain stationary during the step of rotating the drum.

28. The method of claim 22, wherein the light source is supported by the second portion, the method further comprising the step of charging a battery that is both 1) supported by the second portion and 2) electrically connected to the light source.

29. The method of claim 22, wherein the first axis and the second axis are parallel.

30. The method of claim 22, wherein the first axis and the second axis are coincident.
